(19) United States
(12) Patent Application Publication
(10) Pub. No.: US 2015/0371741 A1
(43) Pub. Date: Dec. 24, 2015

(54) METHOD AND APPARATUS FOR TREATING LOGGING CABLE

(71) Applicant: HENRY H. LEGGETT, Brenham, TX (US)

(72) Inventor: HENRY H. LEGGETT, Brenham, TX (US)

(21) Appl. No.: 14/311,183

(22) Filed: Jun. 20, 2014

(51) Int. Cl. H01B 13/00; B23P 6/00; H01B 7/04; B65H 59/16; B65H 59/18; D02G 1/02; B21D 1/06

(52) U.S. Cl. CPC H01B 13/0036; D02G 1/02; B23P 6/00; B21D 1/06; B65H 59/16; B65H 59/18; H01B 7/046

(57) ABSTRACT

A method and apparatus for removing permanent stretch characteristics of electromechanical cable by application of predetermined tension and heat to the cable while continuously moving the cable linearly from a supply drum, through spaced capstans and to a take-up drum. A cable heater is positioned at a braking capstan to soften the polymer insulation of the electrical conductor or conductors and permit tension responsive conductor movement relative to the polymer insulation, thus dissipating the permanent stretch and rendering the cable suitable for accurate well logging and for conducting other downhole well services. The outer cable armor is loosened to start the seasoning process and is tightened as it is taken up at completion of the process.

### BACKGROUND OF THE INVENTION

1. Field of the Invention

The present invention relates generally to the use of electromechanical cable, typically logging cable, in the treatment of wells for enhanced production of petroleum products, such as crude oil, natural gas, distillate and other petroleum constituents. More particularly, the present invention concerns the use of logging cable to accomplish precision location within wells of the various well tools that are employed for well servicing activities. Even more specifically, the present invention concerns one or more processes that are employed to prepare an electromechanical logging cable so that its permanent stretch characteristic is substantially eliminated and permitting a well tool connected with the logging cable to be more precisely located within a well simply by calculating the elastic stretch of the cable.

2. Description of the Prior Art

It is well known in the well drilling and completion industry that wells being drilled must be logged periodically to determine the characteristics of the earth formation and to confirm the location of the drill bit in the earth formation at any point in time. Well logging is typically accomplished by connecting a logging tool to an electromechanical cable, typically referred to as a logging cable, and running the logging tool into the wellbore. In order to accurately locate the logging tool within the wellbore and with respect to the formation various factors must be calculated including the stretch of the logging cable.

Electromechanical cable is typically manufactured with an inner armor having a left hand lay, which is encompassed by an outer armor having a right hand lay. Newly manufactured electromechanical cable typically has elastic stretch characteristics which can be easily calculated, but also has permanent stretch characteristics which are quite difficult to calculate. Each time the electromechanical cable is run down-hole for logging or other well service activities the permanent stretch characteristics change to some extent and adversely affect precision use of the cable, especially for well logging. Consequently, newly manufactured electromechanical cable is not acceptable for accurate well logging since it is difficult to precisely confirm the location of a logging tool within a well. For well logging activities well drilling organizations typically rely on the use of “seasoned” electromechanical cable, i.e., cable that has been run into a deep well and recovered to a spool 10 to 15 or more times.

During each cable run within a deep well a percentage of the permanent stretch characteristics of the cable is depleted and this percentage changes with each cable run. After the cable has been repeatedly run into a deep well and recovered to a cable spool a predetermined number of times, most of the permanent stretch characteristics has been depleted and the cable will have become “seasoned” to the point that only the elastic stretch of the cable need be calculated in order to accurately position a logging tool within a wellbore. Some well drilling companies maintain a deep non-productive well solely for seasoning newly manufactured electromechanical cable. The newly manufactured electromechanical cable must be transported to the designated well and run into the well and retrieved a number of times, for example 10 to 12 times before being transported to a well drilling site for use. Obviously, running and retrieving an electromechanical cable multiple times while doing no income producing work is a time consuming and expensive proposition. Yet, some well drilling organizations maintain a deep well, such as having a depth of 25,000 feet or more, for the sole purpose of facilitating the seasoning of new electromechanical cable to make it ready for accurate well logging and other well service activities.

It is desirable therefore, to provide a method or process and apparatus having the capability of accomplishing accurate and effective seasoning of newly manufactured electromechanical cable in one or more cable processing runs, thus minimizing the time and costs of cable seasoning activities in designated non-productive wells.

### SUMMARY OF THE INVENTION

It is a principal feature of the present invention to provide a novel method and apparatus for applying controlled stretching and working of a newly manufactured electromechanical cable to remove or dissipate a sufficient amount of the permanent stretch characteristics of the cable to render it suitable for accurate well logging activities.

It is another feature of the present invention to provide a novel method and apparatus for processing electromechanical cable by application of controlled tension for cable stretching and controlled application of heat to the cable to temporarily soften polymer insulation of the typically 7 conductors of the cable and permit relative movement of the metal strands of the inner and outer armor. During tension and heat processing the cable is worked by passing it through the multiple cable grooves of a driven capstan and a braking capstan.

Briefly, the various objects and features of the present invention are realized through the provision of a powered or driven capstan and a braking capstan that are located in spaced relation. Each of the capstans has a pair of spaced sheaves, such as 36″ diameter sheaves, each having an external spiral cable groove receiving multiple wraps, for example 10 to 12 wraps of cable, which prevent slippage of the cable as forces are applied to stretch the cable and remove its characteristics of permanent stretch. The spiral grooves of the capstans has a geometric configuration that is designed to precisely fit the cross-sectional dimension and configuration of the electromechanical cable that is being processed. This feature also prevents slippage of the cable during its processing. The electromechanical cable is withdrawn from a supply spool that is mounted on a turntable that is rotated to loosen the outer armor of the cable prior to application of force to stretch the cable. The supply spool or let-off is oriented in spaced relation with the first of the capstans and is recovered by a take-up spool that is also oriented in spaced relation with the capstans. The take-up spool is also mounted on a turntable that is rotated to re-tighten the outer armor of the cable after the cable has been stretched.

Between the spaced sheaves of the first of the capstans is located a cable heating device through which the electromechanical cable passes during its processing. The cable heater is arranged and controlled to accomplish controlled heating of a predetermined length of the cable to a predetermined temperature while the cable is under controlled tension. This feature relaxes the frictional resistance of the polymer insulation with the metal conductor strands and permits movement of the metal conductors relative to the polymer insulation. The cable heater device may be powered electrically for application of radiant heat to the cable that is moving through the cable heater. Alternatively, the cable heater may be gas fired and arranged to apply radiant heat to the moving cable.

After passing through the cable heater the cable is stretched and is then permitted to cool to ambient temperature so that the polymer insulation returns to its hardened state. If desired, the heated cable may be moved through a cooler device, such as a water cooler or refrigerated cooler, so that cooling and hardening of the electromechanical cable will occur more rapidly.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the preferred embodiment thereof which is illustrated in the appended drawings, which drawings are incorporated as a part hereof.

It is to be noted however, that the appended drawings illustrate only a typical embodiment of this invention and are therefore not to be considered limiting of its scope, for the invention may admit to other equally effective embodiments.

In the Drawings:

FIG. 1 is schematic illustration showing an electromechanical cable processing system embodying the principles of the present invention and being arranged to loosen the outer cable armor, apply controlled tension and controlled heat to the cable during its processing for stretching and then re-tighten the outer cable armor after the cable has been stretched;

FIG. 2 is an isometric illustration showing a braking capstan that comprises one of the capstans of the schematic illustration of FIG. 1;

FIG. 3 is an isometric illustration showing a powered or driven capstan that comprises another one of the capstans of the schematic illustration of FIG. 1;

FIG. 4 is an isometric illustration showing a pair of spaced sheaves of a capstan and also showing a multiplicity of cable grooves of the sheaves, with an electromechanical cable being located within the cable grooves of the spaced capstan sheaves;

FIG. 5 is a schematic end view of a single conductor electromechanical cable that is manufactured at the present time by a well-known high quality cable manufacturer;

FIG. 6 is a schematic end view of a three conductor electromechanical cable that is being manufactured, sold and used at the present time; and

FIG. 7 is a schematic end view of a seven conductor high quality electromechanical cable that is also being manufactured, sold and used at the present time.

### DETAILED DESCRIPTION OF PREFERRED EMBODIMENT

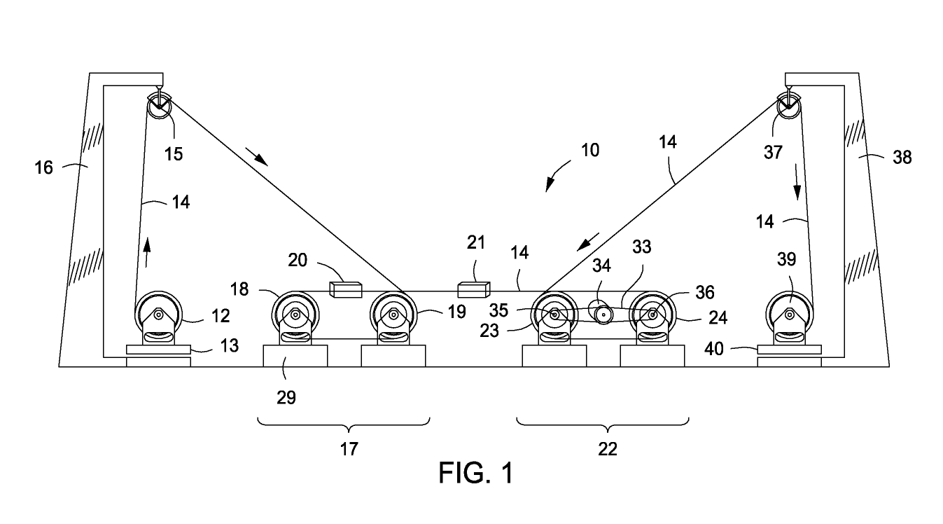

Referring now to the drawings and first to FIG. 1, a schematic illustration of an electromechanical cable processing system, shown generally at 10, includes a rotary supply reel or drum 12 that is mounted on a turntable 13 containing a length, for example 25,000 feet or more, of a particular type of newly manufactured electromechanical cable 14. The electromechanical cable is withdrawn from the cable supply or let-off drum 12 and is directed upwardly and over a sheave 15 while the cable loosening turntable is rotated in a direction for loosening the outer spiral wound armor of the cable and consequently tightening the oppositely wound inner armor. As will be described in greater detail below when the finished cable is taken up it is rotated in the opposite direction by a similar turntable, thereby tightening the spiral wound outer armor substantially to its original condition of tightness and loosening the inner armor substantially to its original condition of tightness. This is done to permit the torque characteristics of the cable to remain balanced during its processing so that the torque characteristics of the finished cable will remain substantially the same as when the cable is removed from the cable supply drum 12. The cable extended upwardly from the cable supply drum 12 and is passed over a cable orienting sheave 15 that is supported by a sheave support structure 16. The cable is loosened during its linear travel from the cable supply drum to the cable orienting sheave 15. The electronically marked electromechanical cable 14 is then passed to a braking capstan shown generally at 17 having spaced externally grooved cable drums 18 and 19. The externally grooved cable drums 18 and 19 each have a plurality of external cable grooves that permit a number of cable wraps, for example 10 to 12 wraps, that extend about the spaced drums of the braking capstan. These multiple wraps of cable ensure against slippage of the cable when tension is applied either by braking activity or capstan driving activity or both. Between the spaced externally grooved sheaves 18 and 19 of the braking capstan 17 is located a cable heater 20 that is positioned to accomplish heating of the cable while it is under tension. The cable may be passed through the cable heater or it may pass in close proximity with the heater so that it is heated to a controlled temperature due to the thermal output of the heater and the speed of substantially continuous cable movement. A tension detecting ohmmeter 21 is located between the braking capstan 17 and a power driven capstan shown generally at 22 for continuously detecting the tension that is being applied to the cable and transmitting an electronic tension signal to the power driven capstan 22 for controlling the tension of the substantially continuously moving electromechanical cable 14 that is being applied by the combined tension developing action of the braking capstan 17 and the power driven capstan 22.

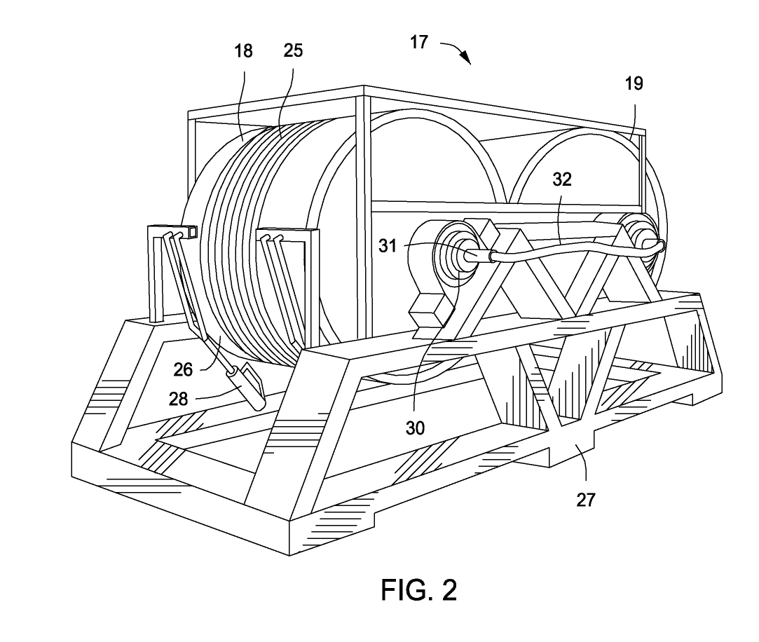

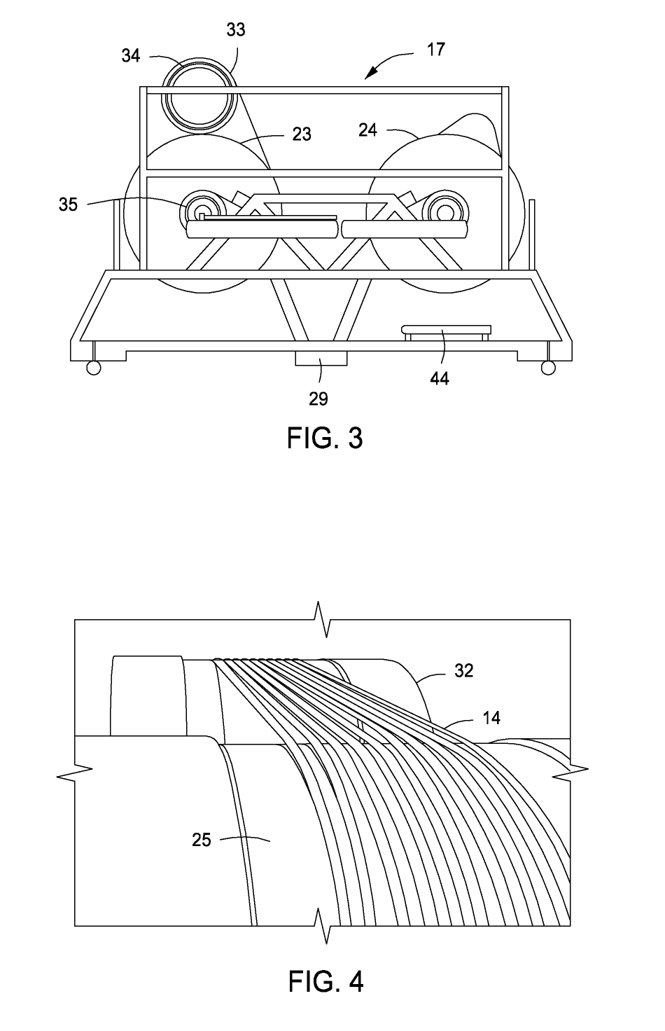

The power driven capstan 22 has a pair of spaced capstan drums 23 and 24, which, like the braking capstan 17, define multiple closely spaced cable grooves 25 that define multiple passes or wraps of cable within the grooves and about the spaced capstan drums as is evident in FIGS. 2 and 4. Typically, a safety cover, such as is shown in FIGS. 2 and 3, is positioned about each of the capstans to prevent workers from coming into contact with the cable grooves or the moving cable being treated. For purposes of simplicity, the capstan drums and multiple wraps of electromechanical cable are shown with the protective cover removed in FIGS. 1 and 4, so that the cable grooves and multiple wraps of cable can be visualized. At least one of the capstan drums 18 or 19 of the braking capstan 17 is provided with one or more brake members 26, as shown in FIG. 2 which is actuated by a hydraulic unit 28 to restrain rotation of the capstan drum and thereby create a braking action that subjects the electromechanical cable to tension as it traverses the multiple cable grooves of the spaced capstan drums and is subjected to tension by the force of the rotating drums of the powered capstan 22. The hydraulic unit 28 may be provided in the form of a hand-pump variety if desired, or it may be mechanically or electro-mechanically controlled to provide the braking system with accurate brake control for maintenance of predetermined cable tension. Capstan drum support structure 29 provides support for drum bearings 30 that provide for rotatable support for the capstan drums. The bearings are provided with a lubricant supply system and have a central passage 31 through which water or other coolant fluid is fed to and from the internal coolant compartment of the capstan drums.

Since substantially continuous application of capstan braking generates considerable heat, the drums 18 and 19 of the braking capstan 17 are of hollow construction, each defining a coolant compartment that contains a volume of coolant fluid such as water. A coolant supply and a coolant receptacle are in heat controlling communication with the coolant compartment and are controlled to ensure that heating of the braking capstan drum or drums is maintained within a predetermined range of temperature. Coolant to and from the internal coolant compartment is provided by passages that are located centrally of the drum bearings 23 and are connected with a coolant supply manifold 32.

A drive belt 33 is driven by a motor 34, such as a rotary electric motor, pneumatic motor or rotary hydraulic motor, and is received by drive pulleys 35 and 36 for driving the drums 23 and 24 of the powered capstan. The drums 23 and 24 of the powered capstan also have multiple cable grooves to establish multiple wraps of cable that extend about the drums and prevent slippage of the cable. The cable leaving the power driven drum 23 extends upwardly to a sheave 37 that is supported by a sheave support structure 38 and is then directed to move downwardly for collection by a take-up spool 39. The take-up spool is mounted for rotation by a turntable 40 which is rotated in a direction for tightening the outer armor of the electromechanical cable 14 and returning the cable to the same conditions as when it is removed from the let-off or cable supply drum 12. The driven capstan 30 is also provided with a braking system that is similar or identical, as compared with the braking system of the capstan shown in FIG. 2 and which is operated by a hydraulic actuator 44, such as a hand-pump or powered actuator.

Referring again to FIG. 1, spaced from the braking capstan 20 is a driven capstan shown generally at 30 having spaced externally grooved capstan drums 32 and 34 which may be substantially identical in size and geometry as compared with the braking capstan drums 22 and 24. The capstan drums are rotatably supported by bearings 36 that are in turn supported by a capstan drum support structure 38. At least one of the capstan drums 32 is rotatably driven by a drive belt 40 that is driven by a rotary motor 42, such as an electric motor, hydraulic or pneumatic motor. The driven capstan 30 is also provided with a braking system that is similar or identical, as compared with the braking system of the capstan shown in FIG. 2 and which is operated by a hydraulic actuator 44, such as a hand-pump or powered actuator.

As mentioned above, heating of the electromechanical cable 14 while it is maintained under predetermined tension is also an important aspect of the present invention. A predetermined length of the cable is heated to soften the polymer insulation of the conductors so that relative movement of the conductors can occur in response to the tension being applied to the cable by the braking and driven capstans, thereby causing most if not virtually all of the permanent stretch characteristics of the cable to be dissipated, leaving the cable in seasoned condition and ready for use during well logging activities. The cable heater 20 is supported between the rotary cable drums of the braking capstan as shown in FIG. 1 and applies radiant heat for a sufficient period of time, while the cable is continuously moving to achieve predetermined softening of the polymer insulation of the conductors and resulting in conductor movement relative to the softened polymer insulation in response to the continuous application of predetermined tension to the cable. As the treated electromechanical cable 14 leaves the proximity of the heater 20 it is typically cooled by ambient temperature. If desired, the heated and treated cable may be controllably cooled by means of refrigerated air or by passing it through a water bath.

The treated electromechanical cable 14 is then passed about a return sheave 37 that is rotatably supported by a sheave support structure 38. The take-up reel or drum 39 is rotatably supported by a turntable 40 and serves to receive the treated and seasoned electromechanical cable 14. Starting and end portions of the cable will not have been adequately treated by application of tension and heat and thus will need to be discarded or electronically marked so that the treated and seasoned section of the cable can be easily identified as the cable is used for well logging and many other activities where the tensile strength and permanent stretch characteristics must be taken into consideration.

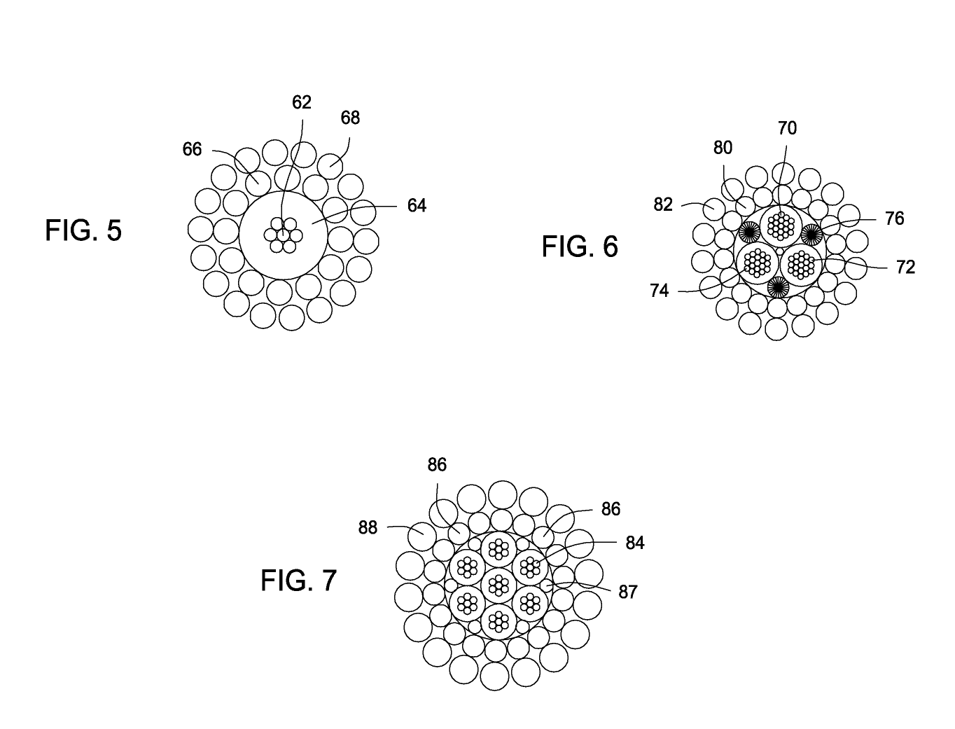

Electromechanical cable for well logging and for other purposes are manufactured in many different forms. FIGS. 5-7 illustrate three forms of electromechanical cable that are currently manufactured and are widely used throughout the well drilling and completion industry. In FIG. 5 the cable has a single conductor 62 that comprises seven strands of metallic conductor wire. Polymer insulation 64 covers the single conductor and is surrounded by inner armor 66 that comprises a number twisted metal wires that are wound about the conductor and an outer armor 68 that also comprises a number of twisted metal wires. As mentioned above, the outer armor typically has a left hand lay while the inner armor has the opposite, or right hand lay. While the electromechanical cable is run into a well the outer armor becomes loosened and the inner armor becomes tightened.

In FIG. 6 a three conductor electromechanical cable is shown, having three polymer coated conductors 70, 72 and 74 with structural members 76 located in conductor grooves. A water barrier 78 surrounds the polymer coated conductors and the structural members to prevent damage by salt water and other well constituents. The cable is provided with a spiral wrapped inner armor 80 and an oppositely spiral wrapped outer armor 82 that are composed of oppositely twisted wires. As mentioned above, the inner armor is composed of multiple wires having a left hand spiral lay and the outer armor is composed of multiple wires having a right hand spiral lay. It should be borne in mind that loosening the outer armor causes tightening of the inner armor.

In FIG. 7 a seven conductor electromechanical cable is shown having seven polymer coated electrical conductors 84 which are contained within a water barrier 86. Structural strands 87 are would within external grooves that are defined by the coated conductors 84. An inner armor 86 and an outer armor 88 are oppositely would about the water barrier 86. Many other types of electromechanical cables are manufactured sold and used by the petroleum industry for well logging and other well servicing activities and can be treated by application of tension and heat for permanent stretch dissipation and seasoning.

### The Cable Seasoning Process

A length of electromechanical cable is provided on a supply reel or drum 12 that is mounted for rotation by a turntable 13. As the cable is pulled from the supply drum 12 upwardly about the cable direction sheave the turntable 13 is rotated in a direction for loosening the outer armor. The outer cable armor which is composed of multiple wires that are wrapped in spiral fashion about the insulation or other wires of the cable with the spiral having a right hand lay. After the cable has been retrieved from the supply reel and loosened by rotation of the turntable 13, multiple wraps of the cable are positioned within the external cable grooves of the spaced drums of a braking capstan. As the last wrap of electromechanical cable is pulled from the first cable drum of the braking capstan a cable heater located between the drums of the braking capstan heats a section of the cable to sufficient temperature for softening of the polymer insulation of the conductors of the cable. The braking action of the braking capstan and the pulling force of the power driven capstan cause this predetermined section of the cable to be subjected to tension, thus subjecting the loosened cable to stretching activity to remove substantially all of the permanent stretch characteristics of the cable. Loosening of the electromechanical cable together with the application of controlled heating in the loosened condition of the cable enhances the cable stretching capability. Subsequent cooling of the heated section of cable will permit the polymer insulation to harden to its original condition, thus stabilizing the stretched cable so that the resulting treated cable will remain with its characteristic of permanent stretch removed. The multiple external cable grooves of each pair of spaced cable drums of the braking and power driven capstans effectively prevents slippage of the cable during the precisely controlled cable stretching process.

The cable is loosened to start the tension and heat responsive seasoning process. The electromechanical cable is supplied on a let-off drum that is mounted for rotation by being supported by a rotary turntable. As the electromechanical cable is paid out from the let-off or cable supply drum the turntable is rotated in a direction for loosening the spiral wound outer armor of the cable and for tightening the oppositely wound inner armor. The leading end of the electromechanical cable is contacted by a tension control sheave and is looped about a return sheave and is connected to a take-up reel or drum. The electromechanical cable is also passed through or in close proximity with a heater unit that is located between the drums of the braking capstan and may also be passed through or in close proximity with a cable cooling unit the is located downstream from the heater unit. The cable remains torque balanced during the stretching or seasoning process so that the torque characteristics of the finished cable are substantially the same as when the cable seasoning process is started.

With the brake of the braking capstan set for application of predetermined tension to the electromechanical cable and with the heater unit in operation, the driven capstan is actuated to move the cable substantially continuously and to apply predetermined tension to the cable as it is moved through or in close proximity with the heater unit to soften the polymer insulation of the conductors and permit relative movement of the conductors with respect to the polymer insulation surrounding the conductors. The application of heat and tension to the cable causes the permanent stretch characteristics of the cable to be virtually dissipated, leaving the cable seasoned for accurate and efficient use during well logging activities.

Though a pair of double drummed capstans are preferably employed for applying controlled tension to the electromechanical cable during processing for dissipation of the permanent stretch characteristics of the cable, it is to be understood that the present invention is not restricted or limited to this particular arrangement of cable stretching apparatus. The present invention is practiced by employing any suitable apparatus for application of controlled tension to the electromechanical cable and by applying predetermined heat to the cable while it is under tension to thus permit cable stretching for the purpose of removing or dissipating the permanent stretch characteristics of the cable. controlled movement of the cable conductors relative to the polymer coating that is present and then causing hardening of the polymer coating while the cable is maintained under tension. As the cable is being processed the torque characteristics of the cable remains balanced. As the cable seasoning process is completed the cable is passed about tension control and return sheaves and is then recovered to a take-up spool or drum, thus readying the cable for shipment to a site for use in well logging or other well servicing activities.

In view of the foregoing it is evident that the present invention is one well adapted to attain all of the objects and features hereinabove set forth, together with other objects and features which are inherent in the apparatus disclosed herein.

As will be readily apparent to those skilled in the art, the present invention may easily be produced in other specific forms without departing from its spirit or essential characteristics. The present embodiment is, therefore, to be considered as merely illustrative and not restrictive, the scope of the invention being indicated by the claims rather than the foregoing description, and all changes which come within the meaning and range of equivalence of the claims are therefore intended to be embraced therein.

I claim:

1. A method for processing electromechanical cable having one or more polymer coated electrical conductors and having oppositely twisted inner and outer armor to substantially dissipate the permanent stretch characteristics thereof, comprising:
moving the electromechanical cable from a supply drum;
loosening the electromechanical cable as it is moved from said supply drum;
moving the electromechanical cable linearly and substantially continuously from a supply drum to a take-up drum;
substantially continuously applying predetermined tension to a section of the electromechanical cable during said step of moving the electromechanical cable, said predetermined tension causing movement of the electrical conductors relative to the polymer coating of the electromechanical cable and substantially dissipating the permanent stretch characteristics of the electromechanical cable;
tightening the outer armor of the electromechanical cable; and
recovering the stretched and tightened electromechanical cable to a take-up drum.

2. The method of claim 1, comprising:
said step of loosening the outer armor of the electromechanical cable being rotation of said cable supply drum in a direction opposite the spiral wrapping direction of the outer armor; and
said step of tightening the outer armor of the electromechanical cable being rotating the cable take-up drum in the direction of the spiral wrapping direction of the outer armor.

3. The method of claim 1, comprising:
applying predetermined heat to said electromechanical cable during said step of moving the electromechanical cable and during maintenance of said electromechanical cable under predetermined tension, said predetermined heat softening said polymer coating of said electrical conductors and permitting said movement of said electrical conductors relative to said polymer coating and substantially dissipating the permanent stretch characteristics thereof.

4. The method of claim 1, comprising:
establishing multiple wraps of the electromechanical cable within the spiral cable grooves of first and second spaced rotary cable drums;
applying braking to said first rotary cable drum; and
causing power energized rotary driving of said second rotary cable drum, said braking and driving applying said predetermined tension to the electromechanical cable during its substantially continuous linear movement.

5. The method of claim 4, comprising:
applying predetermined heat to a section of said electromechanical cable between said first and second spaced rotary cable drums, said predetermined heat softening the polymer coating of the electrical conductors and permitting said movement of said electrical conductors relative to said polymer coating responsive to application of tension to the electromechanical cable; and
cooling the electromechanical cable prior to engagement of the electromechanical cable by said second rotary cable drum.

6. The method of claim 1, comprising:
providing first and second spaced capstans each having a spaced pair of cable drums each cable drum having a spiral cable groove extending multiple times about the external periphery thereof;
extending multiple wraps of electromechanical cable within said spiral cable groove of each pair of cable drums of said first and second spaced capstans and with a single length of said electromechanical cable extending between said first and second spaced capstans;
applying braking to a cable drum of said first capstan for application of brake induced tension to said single length of the electromechanical cable;
applying powered rotation to a cable drum of said second capstan for powered linear movement of the electromechanical cable between said first and second capstans; and
collecting electromechanical cable moving linearly from said second capstan to a take-up drum.

7. The method of claim 6, comprising:
cooling said cable drum of said first capstan to minimize heat build-up in response to braking activity.

7. A method for processing electromechanical cable having one or more polymer coated electrical conductors and having oppositely twisted inner and outer armor to substantially dissipate the permanent stretch characteristics thereof, comprising:
moving the electromechanical cable linearly and substantially continuously from a supply drum to a take-up drum;
substantially continuously applying predetermined tension to the electromechanical cable during said step of moving the electromechanical cable; and
applying heat to the electromechanical cable while the electromechanical cable is maintained under predetermined tension to soften the polymer insulation of the electrical conductors and permitting movement of the electrical conductors relative to the polymer coating thereof and substantially dissipating the permanent stretch characteristics of the electromechanical cable and rendering it to seasoned condition for use in wells for well logging and other well servicing activities.

8. The method of claim 7, comprising:
providing first and second spaced capstans each having a spaced pair of cable drums each cable drum having a spiral cable groove extending multiple times about the external periphery thereof;
extending multiple wraps of electromechanical cable within said spiral cable groove of each pair of cable drums of said first and second spaced capstans and with a single length of said electromechanical cable extending between said first and second spaced capstans;
applying braking to a cable drum of said first capstan for application of brake induced tension to said single length of the electromechanical cable;
applying powered rotation to a cable drum of said second capstan for powered linear movement of the electromechanical cable between said first and second capstans; and
collecting electromechanical cable moving linearly from said second capstan to a take-up drum.

10. The method of claim 8, comprising:
establishing multiple wraps of the electromechanical cable within the spiral cable grooves of first and second spaced rotary cable drums;
applying braking to said first rotary cable drum;
causing power energized rotary driving of said second rotary cable drum, said braking and driving applying said predetermined tension to the electromechanical cable during its substantially continuous linear movement;
said step of applying predetermined heat to a section of said electromechanical cable being passing the electromechanical cable in close proximity of a heater located between said first and second spaced rotary cable drums, said predetermined heat softening the polymer coating of the electrical conductors and permitting said movement of said electrical conductors relative to said polymer coating responsive to application of tension to the electromechanical cable; and
cooling the electromechanical cable prior to engagement of the electromechanical cable by said second rotary cable drum.

11. Apparatus for applying predetermined tension and predetermined heat to electromechanical cable for seasoning of the electromechanical cable and rendering it suitable for well logging activities, comprising:
a supply drum mounted for rotation and having spooled thereon a length of electromechanical cable to be processed to substantially dissipate the permanent stretch characteristics of the electromechanical cable;
a rotary braking drum and a rotary powered drum being disposed in spaced relation, each drum having an external spiral cable groove extending a number of times about the outer periphery of said braking drum and said powered drum;
electromechanical cable drawn from said supply drum being positioned within said external spiral cable groove and establishing multiple cable wraps about said braking drum and said powered drum, with a single length of the electromechanical cable extending across the space between said braking drum and said powered drum, the single length of electromechanical cable being subjected to tension by braking activity of said braking drum and simultaneous power energized rotation of said powered drum, said tension causing movement of the electrical conductors of the conductors of the electromechanical cable relative to the polymer coating of the electrical conductors and serving to substantially dissipate the permanent stretch characteristics of the electromechanical cable; and
a take-up drum being positioned to retrieve processed electromechanical cable exiting linearly from said rotary powered drum.

12. The apparatus of claim 11, comprising:
said rotary braking drum being in the form of a capstan having a pair of spaced rotary drums, with each of said pair of spaced rotary drums defining an external cable groove extending multiple times about the outer periphery of at least one of said spaced rotary drums;
a brake mechanism being mounted for application of braking to said at least one of said spaced rotary drums; and
a brake actuator being connected with said brake mechanism to retard rotation of said rotary braking drum.

13. The apparatus of claim 11, comprising:
a heater being located between said rotary braking drum and said power driven drum and being located in close proximity to said single length of the electromechanical cable, said heater being controlled to apply sufficient heat to a section of said single length of electromechanical cable during linear cable movement and while said single length of electromechanical cable is maintained under predetermined tension by said rotary braking drum and said rotary power driven drum to soften the polymer insulation of the cable conductors and permit relative movement of the electrical conductors and the polymer insulation.

14. The apparatus of claim 11, comprising:
said cable drums of said braking capstan defining coolant compartments; and
a coolant supply and receiving system being in fluid communication with said coolant compartments and circulating coolant fluid through said coolant compartments for removing brake generated heat from said cable drums.

15. The apparatus of claim 11, comprising:
said external spiral cable grooves of said rotary braking drum and said rotary power driven drum receiving multiple wraps of the electromechanical cable to ensure against slippage of the electromechanical cable within said external spiral cable grooves;
a brake system mounted for application of braking to said first rotary cable drum;
said rotary power driven drum applying tension to the electromechanical cable extending between said rotary braking and rotary power driven drums and causing substantially continuous linear movement of the electromechanical cable; and
a heater being located between said rotary braking drum and said power driven drum and being located in close proximity to the electromechanical cable, said heater being controlled to apply sufficient heat to the electromechanical cable during linear cable movement and while said single length of electromechanical cable is maintained under predetermined tension to soften the polymer insulation of the cable conductors and permit relative movement of the electrical conductors and the polymer insulation.

16. The apparatus of claim 15, comprising:
a cooling system being located between said rotary braking drum and said rotary power driven drum and cooling the electromechanical cable prior to engagement of the electromechanical cable by said rotary power driven drum.

17. The apparatus of claim 15, comprising:
a rotary take-up drum being positioned to receive tension and heat processed electromechanical cable exiting linearly from said rotary power driven drum.

18. The apparatus of claim 11, comprising:
a first rotary turntable supporting said cable supply drum and during linear movement of the electromechanical cable from said cable supply drum said rotary turntable rotating said cable supply drum in a direction loosening the outer armor of the electromechanical cable; and
a second rotary turntable supporting said rotary take-up drum and being rotated in a direction tightening the outer armor of the electromechanical cable as the treated electromechanical cable is taken up by said rotary take-up drum.
